(19) United States
(12) Patent Application Publication
(10) Pub. No.: US 2011/0027603 A1
(43) Pub. Date: Feb. 3, 2011

(54) Enhancing Thermal Properties of Carbon Aluminum Composites

(75) Inventors: Zvi Yaniv, Austin, TX (US); Igor Pavlovsky, Cedar Park, TX (US); Nan Jiang, Austin, TX (US); James P. Novak, Austin, TX (US); Richard Fink, Austin, TX (US); Mohshi Yang, Austin, TX (US); Dongsheng Mao, Austin, TX (US); Samuel Kim, Austin, TX (US)

Correspondence Address: LEE & HAYES, PLLC, 601 W. RIVERSIDE AVENUE, SUITE 1400, SPOKANE, WA, 99201, US

(73) Assignee: Applied Nanotech, Inc., Austin, TX (US)

(21) Appl. No.: 12/629,853

(22) Filed: Dec. 2, 2009

Related U.S. Application Data
(60) Provisional application No. 61/119,562, filed on Dec. 3, 2008.
(60) Provisional application No. 61/147,628, filed on Jan. 27, 2009.

(51) Int. Cl. B32B 5/18; B32B 3/26; B21C 23/24

(52) U.S. Cl. 428/550; 428/320.2; 72/46

(57) ABSTRACT

An article of manufacture comprises a carbon-containing matrix. The carbon-containing matrix may comprise at least one type of carbon material selected from the group comprising graphite crystalline carbon materials, carbon powder, and artificial graphite powder. In addition, the carbon-containing matrix comprises a plurality of pores. The article of manufacture also comprises a metal component comprising Al, alloys of Al, or combinations thereof. The metal component is disposed in at least a portion of the plurality of pores. Further, the article of manufacture comprises an additive comprising at least Si. At least a portion of the additive is disposed in an interface between the metal component within the pores and the carbon-containing matrix. The additive enhances phonon coupling and propagation at the interface.

### CROSS-REFERENCE TO RELATED APPLICATION

This application claims the benefit under 35 U.S.C. §119(e)(1) of U.S. Provisional Application No. 61/119,562, filed Dec. 3, 2008, which is hereby incorporated by reference and this application also claims the benefit of U.S. Provisional Application No. 61/147,628, filed Jan. 27, 2009, which is hereby incorporated by reference.

### BACKGROUND

This application is directed to enhancing thermal properties and physical properties of carbon aluminum composites.

### SUMMARY

The instant article of manufacture comprises a carbon-containing matrix. The carbon-containing matrix may comprise at least one type of carbon material selected from the group comprising graphite crystalline carbon materials, carbon powder, and artificial graphite powder, or combinations thereof. In addition, the carbon-containing matrix comprises a plurality of pores. The article of manufacture also comprises a metal component comprising Al, alloys of Al, or combinations thereof. The metal component is disposed in at least a portion of the plurality of pores. Further, the article of manufacture comprises an additive comprising at least Si. At least a portion of the additive is disposed in the interface between the metal component within the pores and the carbon-containing matrix. The additive enhances phonon coupling and propagation at the interface. The additive may comprise between 5% and 11% by mass of the metal component. In addition, the interface may comprise Si crystals, SiₓC_{y}, AlₐSi_{b}C_{c}, or combinations thereof. In some instances, the instant article of manufacture may be free from or contain only trace amounts of Al₄C₃, such as less than 1% Al₄C₃.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and elements.

FIGS. 1A and 1B show a Scanning Electron Microscope (SEM) image of higher quality acicular coke and lower quality coke.

FIG. 2 illustrates SEM images of coarse graphite particle structures and fine graphite particle structures.

FIG. 3 is a flow diagram showing a method for making a carbonaceous matrix.

FIG. 4 shows an example of a Raman spectrum of a carbonaceous matrix.

FIG. 5 shows Transmission Electron Microscope (TEM) images of a carbonaceous matrix.

FIGS. 6A and 6B show additional TEM images of the nanographitic plates of the carbonaceous matrix.

FIGS. 7A and 7B show TEM diffraction patterns and images of the carbonaceous matrix.

FIG. 8 shows a flow diagram of a method of manufacturing a carbon-aluminum composite thermal management material.

FIGS. 9A and 9B illustrate heat transfer devices that may utilize a carbon-aluminum composite.

FIG. 10 illustrates formation of an interface between carbon and aluminum within pores of a carbonaceous matrix.

FIG. 11 shows a very high magnification TEM image of the interfacial layer showing an interface between graphitic carbon and aluminum filling material.

FIGS. 12A, 12B, and 12C show TEM images, taken at various locations in a carbon-aluminum composite material.

FIG. 13A shows a Scanning Electron Microscope (SEM) image for a carbon-aluminum composite and FIG. 13B shows a corresponding Energy Dispersive X-ray (EDX) analysis for the carbon-aluminum composite.

FIG. 14 shows a tertiary phase diagram for silicon, aluminum, and carbon.

FIG. 15 shows a phase diagram for aluminum and silicon.

FIG. 16 shows a graph of a Raman spectra of a carbon-aluminum composite.

FIG. 17 shows a graph of a Raman spectra of the aluminum-rich area in the carbon-aluminum composite.

FIG. 18 shows a graph of an x-ray diffraction pattern (XRD) of the carbon-aluminum composite.

FIG. 19 shows a graph of reference peaks for XRD peak identification.

### DETAILED DESCRIPTION

The instant thermal management composite includes a metal, a carbonaceous backbone, and additives. The thermal management composite may achieve tailored thermal properties by the addition of specific additives to the starting materials. These additives can:
1) Control the quality of the carbonaceous backbone;
2) Result in an interface layer between the metal and carbonaceous backbone that serves to increase overall thermal conductivity;
3) Suppress unwanted chemical byproducts that reduce performance of the composite; and
4) Provide specific chemical products that enhance the performance of the composite.
   These results can enhance the thermal and physical properties of the composite.

Without being bound to any theory, heat conduction is governed by differences in temperature (temperature gradient) as described in the following equation 1.

\vec{Φ}_{q}=−κ\vec{∇}T Eq. 1

where Φ_{q} is the heat flux in W m⁻², T(ŕ) is the temperature field in Kelvin, and κ is the thermal conductivity in W·m⁻¹·K⁻¹. As heat energy is transported to/from an infinitesimal volume the local temperature changes according to the specific heat capacity of the material as defined by the following equation 2.

$$dT = \frac{dQ}{{C}_{p} ρ} \qquad Eq . 2$$

where Cₚ is the specific heat capacity at constant pressure in J·kg⁻¹·K⁻¹.

Putting these two principles together leads to the heat equation as defined by the following equation 3.

$$\frac{\partial T}{\partial t} = α {∇}^{2} T \qquad Eq . 3$$

where α is the thermal diffusivity in m²·s⁻¹, and α is given by the following equation 4.

$$α = \frac{κ}{{C}_{p} ρ} \qquad Eq . 4$$

where ρ is the material density in kg·m⁻³. The product Cₚρ is also known as the volumetric heat capacity. For a 1-dimensional system the Green's function is given by the following equation 5.

$$G ( x , t ) = \frac{1}{\sqrt{4 π α t}} {e}^{- \frac{{x}^{2}}{4 α t}} \qquad Eq . 5$$

The Green's function in equation 5 is the solution of equation 3 for a δ-function initial temperature distribution at x=0 in material having infinite extent. The 3-dimensional Green's function for equation 3 is defined by the following equation 6.

$$G ( \vec{r} , t ) = \frac{1}{{( 4 π α t )}^{\frac{3}{2}}} {e}^{- \frac{{\vec{r}}^{2}}{4 α t}} \qquad Eq . 6$$

which is the temperature field evolutionary response for a δ-function initial temperature at ŕ=0.

### Introduction

Thermal conductivity may be based upon three major contributions; electron, phonon and magnetic. The total thermal conductivity (equation 7) can be written as a sum of each contributing term:

kₜₒₜₐₗ=k_{electronic}+kₚₕₒₙₒₙ+k_{magnetic} Eq. 7

The first contribution, k_{electronic}, is due to electron-electron interactions between materials. Energy transfer via electron-electron interactions is a direct effect of shared electrons within a crystal structure. The second term, kₚₕₒₙₒₙ, is related to phonon coupling. A phonon is a lattice vibration within a crystal structure. These lattice vibrations can propagate through a material to transfer thermal energy. Highly ordered materials with regular, crystalline lattice structures transfer energy more efficiently than regio-regular or non-crystalline materials. The third contribution to thermal conductivity, k_{magnetic}, relies on magnetic interactions. Metals can be used in composites in order to maximize magnetic interactions. For example, metals such as Ni, Fe, and Co have a magnetic moment. Increased energy transfer via magnetic interactions may be due to aligned electron spin and the resulting coupling between the spins.

Thermal characteristics of composites, such as composites of a material A and a material B, may be affected by the quality and the nature of the interfaces between the grains of material A and the grains of material B. In particular, the quality of the interfaces that form the composite may be affected by: the quality of phonon coupling and phonon propagation between the grains of materials A and materials B; the creation of compounds of AₓB_{y} that change the nature of the interface and change the expected value of the thermal impedance at the interface; and the adhesion strength at the interfaces of grains of A and B, where the adhesion strength may affect not only the thermal properties but also the final mechanical strength of the composite. Additives, such as materials C, can create a secondary interface at the grain boundaries such that AₓC_{z}, B_{y}C_{z}, or AₓB_{y}C_{z} materials are formed that enhance the thermal properties or mechanical strength of the material. These additives, C, can also suppress formation of combinatorial intermediate phases that can be detrimental to the performance of the material.

In an illustrative example including a carbon aluminum composite thermal management material, a metal carbide may form at the surface between the C and Al moieties that plays a role in the overall thermal conductivity of the composite. In some embodiments, dopant materials added to the carbon aluminum composite at particular concentrations may maximize the thermal conductivity across the metal carbon interface.

### Overview

This disclosure describes a carbonaceous matrix (also referred to herein as a “carbon-containing matrix” or a “carbonaceous backbone”) that includes very organized graphitic carbon with very small particulates that have been aligned and are then heated under high pressure to create a porous, carbonaceous backbone material. The carbonaceous backbone material is then impregnated with molten metal under high heat and pressure. The addition of the metal increases the strength of the carbonaceous backbone, as well as, enhancing the physical properties by filling in voids of the carbonaceous backbone.

A careful choice of metal or metal alloys can create a strong material, with excellent thermal management properties, that is easily machined to the desired shape, and is recyclable. In some embodiments the metal may be aluminum, which has a lower cost and results in a lower process temperature, while maintaining excellent favorable thermal properties. In other embodiments, the metal may be copper, which also has excellent thermal properties, but may have a high mass and require a high process temperature. However, the process is not limited to these two examples.

To improve upon the thermal properties of the composite there may be trace additives to the base metal. Possible additives include, but are not limited to Ge, Pb, Si, Sn, Ti, Cr, Mg, Mn and Cu. These additives can enhance the ability to impregnate the carbonaceous backbone. For example, some additives may change the surface tension of the metal to help the metal flow into the carbonaceous matrix. In addition, additives may enhance the quality of the interface between the metal and the carbonaceous backbone. The quality of the interface may affect the mechanical strength of the composite and may affect the thermal properties of the composite.

In an illustrative example, aluminum and silicon may be added to a carbonaceous backbone. In this example, the total thermal conductivity can be determined based upon contributions from the aluminum, carbon, and silicon. To illustrate, aluminum may have high contributions to thermal conductivity from electronic and phonon components. Further, the graphite in the matrix has excellent electronic contributions within a single plane, yet poor phonon coupling between planes. Silicon may affect the quality of a carbonaceous backbone, the nature of an interface between the carbon and aluminum, and the quantity of intermediates, such as aluminum carbide, in the matrix. In particular, the silicon may contribute to the thermal conductivity of the composite by producing an interface between the graphitic carbon and the aluminum that allows energy transfer through enhanced electron and phonon coupling and transmission.

In some embodiments, the thermal management composite may be utilized as a heat transfer material. Heat transfer materials may spread heat to the environment and remove heat from hot spots quickly and efficiently. Most high-power, high-speed electronic devices and systems require high thermal diffusivity materials to modulate temperature and eliminate or reduce the effects of hot spots. Thermal diffusivity is the ratio of thermal conductivity to volumetric heat capacity. Materials with high thermal diffusivity conduct heat quickly in comparison to their volumetric heat capacity (thermal bulk), meaning that the temperature wave moves quickly from the hot spot to the surroundings. When selecting a heat transfer material for a particular application, in addition to thermal diffusivity, other factors to consider are a material's coefficient of thermal expansion (CTE), weight, ease of processing, and price

### Manufacturing the Carbonaceous Matrix

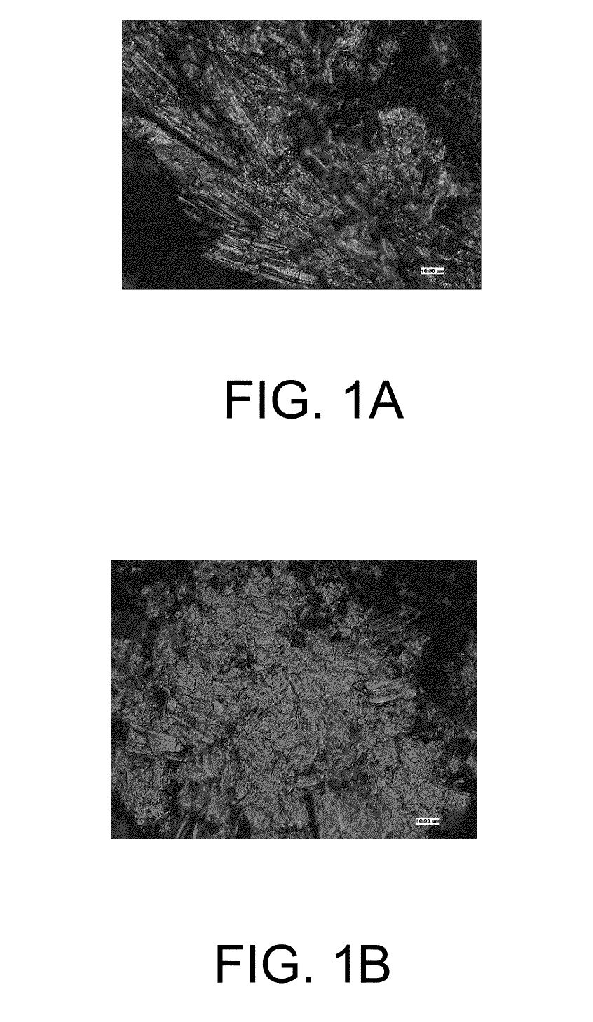

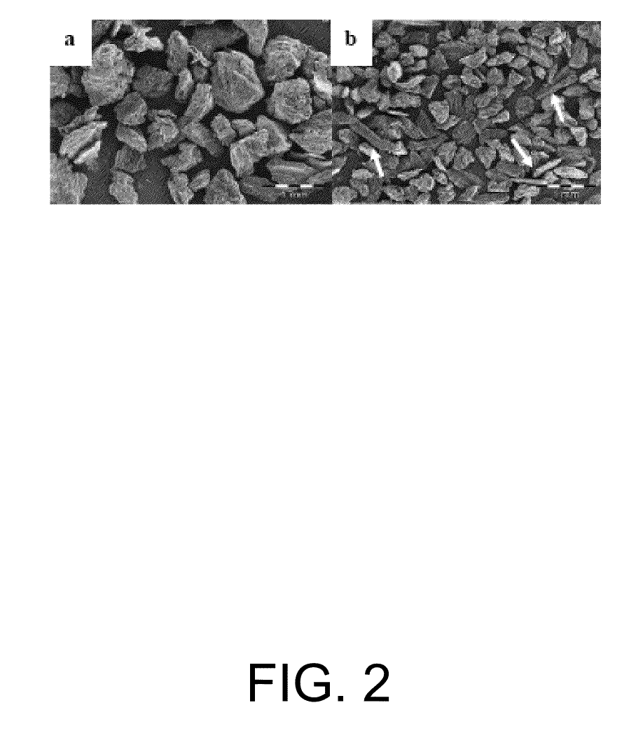

The graphitic carbon of the carbonaceous matrix may be based upon industrial coke products. This carbon residue can be derived from natural sources or from refining processes, such as in the coal and petroleum industries. In some embodiments, higher quality acicular coke derived from petroleum products may be utilized to form the carbonaceous matrix. FIG. 1A shows a Scanning Electron Microscope (SEM) image of higher quality acicular coke compared to lower quality coke shown in FIG. 1B. Pitch/tar may also be added to the acicular coke to function primarily as a binder and is turned to graphitic carbon during heating at a temperature of 2600° C. or higher, typically in the range of 3200° C. to 3600° C. The raw graphite material may include coarse and fine graphite particles with an average size in the range of 0.2 mm to 2 mm. In some embodiments, about 10% of the particles exhibit ellipse-like shape. FIG. 2 illustrates SEM images of coarse particle structures in the picture labeled “a” and fine particle structures in the picture labeled “b” with ellipse-like particles indicated by arrows.

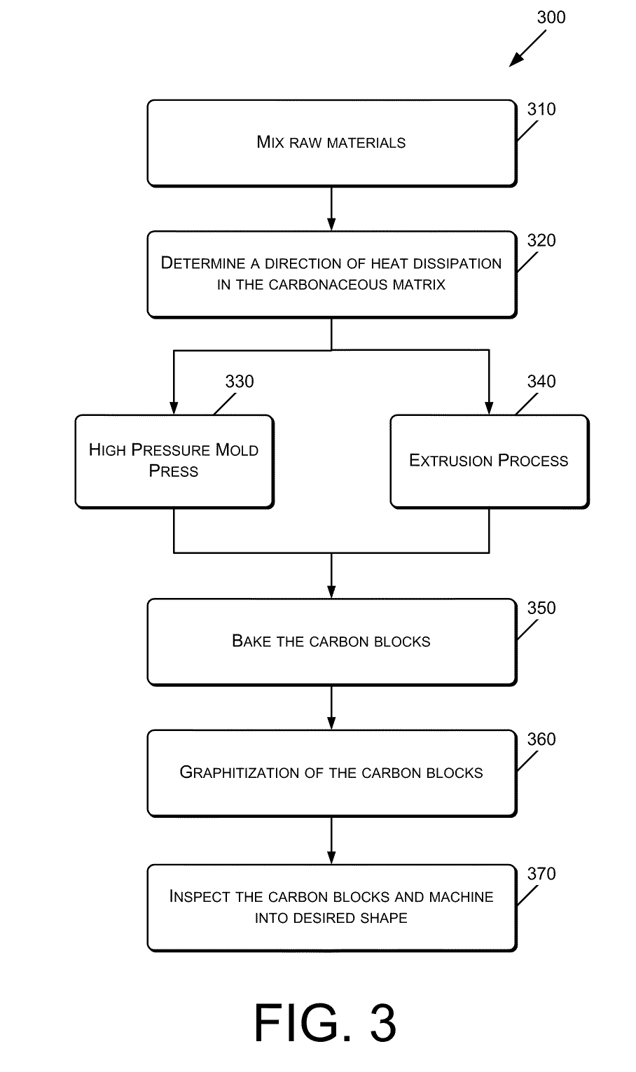

FIG. 3 is a flow diagram showing a method 300 for making a carbonaceous matrix. At 310, the raw materials are mixed together. During the mixing process, three raw materials may be used—petroleum cork, needle cork, tar (liquid), or a combination thereof. The needle cork may be used to control the shape of the carbonaceous matrix and lower the resistivity of the final carbonaceous matrix. The liquid tar may also used to control the shape of the carbon block and fill in pores of the carbonaceous matrix. The petroleum cork and the needle cork are crushed and mixed at a ratio of about 10:1, although different ratios may be used. The mixture is then subjected to a calcining process at about 500° C. or higher to evaporate impurities, such as sulfur. The liquid tar is then dosed into the mixture. In some embodiments, needle cork and tar may be used to make the carbonaceous matrix without the petroleum cork because the needle cork has a higher carbon content, lower sulfur content, lower thermal expansion coefficient, higher thermal conductivity, and is easier to form than the petroleum cork.

At 320, the method 300 includes determining a direction of heat dissipation in the carbonaceous matrix. For example, a carbonaceous matrix may dissipate heat faster in the Z-direction when the carbonaceous matrix is manufactured utilizing an extrusion process. In another example, a carbonaceous matrix may dissipate heat faster in the XY direction when the carbonaceous matrix is manufactured utilizing a high pressure mold press. When heat dissipation along the XY direction is specified, then the method 300 moves to 330 where the carbonaceous matrix is formed by placing the raw materials in a high pressure mold press at a pressure higher than 50 MPa. Otherwise, when heat dissipation along the Z direction is specified, then the method 300 moves to 340.

At 340, the raw materials mixture of petroleum cork, needle cork, and/or tar is fed into an extruding process to form carbon blocks based on the shape and size of a mold utilized to make the carbonaceous matrix. In an illustrative embodiment, a carbon mold may be cylindrical with a diameter of about 700 mm and a length of about 2700 mm having a weight of at least about 1 ton. However, the dimensions of the mold can be changed based on the capabilities of the processing facility. The extruding process may be performed at a temperature range of 500° C. to 800° C. The force utilized to press the mixture into a column shape is about 3500 tons applied for about 30 minutes. In some instances, the extruded carbon blocks may be processed using a high pressure mold press. The carbon blocks are then transferred to a cooling water bath to cool down in order to prevent cracking.

At 350, the blocks are baked. The baking process can carbonize the tar at high temperature and eliminate volatile components. In a particular embodiment, the carbon blocks are transported from the cooling bath to an oven and heated at a temperature of about 1600° C. In some embodiments, the carbon blocks are baked for a duration in the range of 2 to 3 days. After the baking process, the surface of the carbon blocks may become rougher and porous. In addition, the diameter of the carbon block may decrease by about 10 mm.

At 360, graphitization takes place by heating the carbon block at a temperature in a range of 3200° C. to 3600° C. In some embodiments, graphitization will start at about 2600° C. with higher quality graphite forming at about 3200° C. In particular, at about 3000° C., stacking of graphitic plates of the carbon block may become parallel and turbostatic disorder decreases or is eliminated. In some embodiments, the carbon block may be heated to a lower temperature to produce crystallized graphite if the heating occurs at higher pressures. In an illustrative embodiment, the carbon blocks are heated for about 2-3 days. During the heating process, sulfur and volatile components of the carbon block may be reduced or completely eliminated.

At 370, the carbon blocks are inspected and machined into a desired shape. For example, electrical properties of the carbon blocks may be tested and mechanical cracking or visually identifiable defects are checked prior to the next stages of production. After testing, the carbonaceous matrix may then be machined to specific shapes according to the use of the carbon blocks.

The carbonaceous matrix may include various forms of carbon and trace amounts of other materials. For example, the carbonaceous matrix may include graphite crystalline carbon materials, carbon powder, artificial graphite powder, carbon fibers, or combinations thereof. The carbonaceous matrix block may have a density in a range of 1.6 g/cm³ to 1.9 g/cm³. In addition, the resistivity of the carbon block may be in a range between 4 μΩ m to 10 ρΩ m. In particular embodiments, the resistivity of the carbonaceous matrix is about 5 μΩ m. A lower resistivity of the carbon block may indicate better alignment of the graphitic sheets of the carbonaceous matrix, which may also provide a higher thermal conductivity.

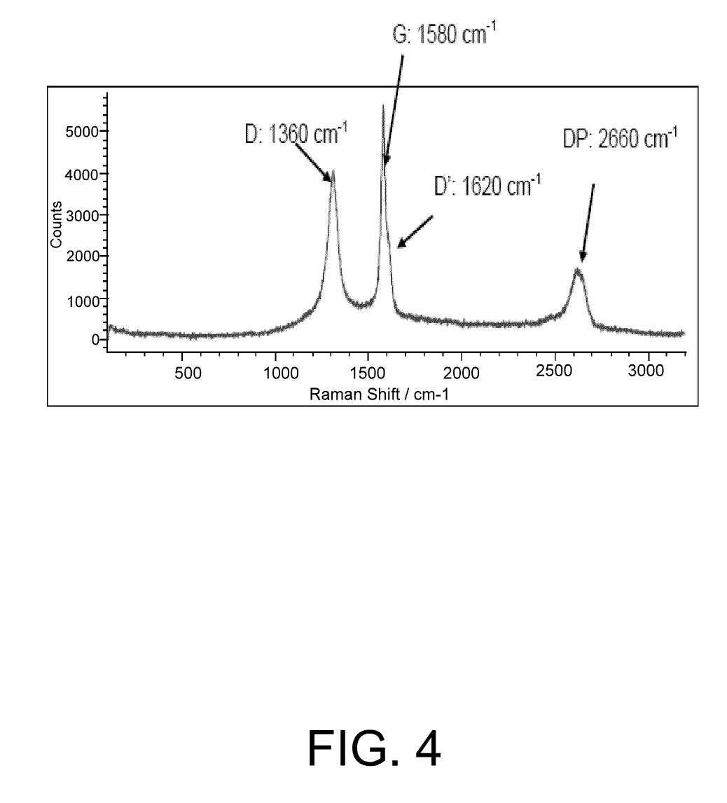

In some instances, following the formation of the carbonaceous matrix, the material may be analyzed using Raman Spectroscopy. In particular, FIG. 4 shows an example of a Raman spectrum of the carbonaceous matrix having three distinct peaks at about 1360 cm⁻¹, at about 1580 cm⁻¹ and at about 2660 cm⁻¹. The first two peaks may be identified as first order modes of vibration. The peak at about 1360 cm⁻¹ is the A_{1g} breathing mode of the Brillouin Zone edge. This can be referred to as the D band. The second peak at about 1580 cm⁻¹ is the E_{2g} inplane breathing of the sp² carbons. This can be referred to as the G band. The third peak at about 2660 cm⁻¹ is the full second order coupling peak of the D band labeled “DP” in FIG. 4. There is also a 4^{th} band that may arise as a shoulder on the 1580 cm⁻¹ G band with a location at about 1620 cm⁻¹. This band may be referred to as the D′ (D prime) band. The primary D band may indicate disordered carbon content, but the appearance of the D′ band may mean that the degree of disorder has been reduced or some disordered content has been changed into graphite crystallites.

In FIG. 4, each of the first two peaks, that is the D and G peaks, is sharp and may be easily resolved almost completely to baseline indicating that the graphitic carbon may be formed at relatively high temperature and is well crystallized. The sharp and pronounced Raman spectra indicate high-grade crystallization of graphitic carbon. The major second order peak at 2660 cm⁻¹ is due to ordering along the c-axis or Z-direction. The Z-direction is perpendicular to the plane of the graphitic sheet. The thicker the material the stronger the c-axis coupling will be and the more pronounced the Raman peaks.

The peak width (full width at half maximum, FWHM) is determined to be 25 cm⁻¹ for the G band. The narrower the peak width, the more ordered the graphite. In one example, a FWHM less than 40 cm⁻¹ may represent highly ordered graphite. Additionally, the size of the graphitic carbon grains can be determined by the analysis of the G band peak width. Further, the intensity ratio of the D to G band (I_{d}/I_{g}) may depend on the size of the local graphitic domains. In some embodiments, the I_{d}/I_{g} ratio may be from about 0.5 to about 0.9. An I_{d}/I_{g} ratio in this range may suggest the graphite particles are at least larger than about 5 nm and have good crystallinity. In FIG. 4, the I_{d}/I_{g} measures 0.7 and may represent very small crystallites with a high degree of ordering and good graphite crystallinity. The existence of the small crystallites may aid in the interlayer phonon coupling of the graphitic carbon.

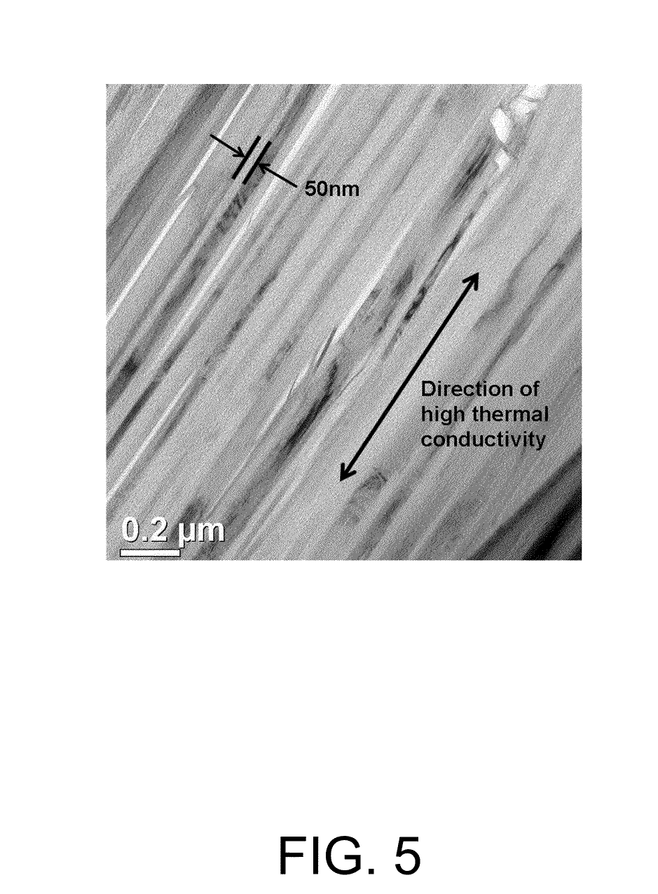

FIG. 5 shows Transmission Electron Microscope (TEM) images of the carbonaceous matrix. The TEM images of FIG. 5 indicate the formation of stacks of graphitic plates, with sizes less than about 100 nm. FIG. 5 shows a specific example of a graphitic plate having a thickness of about 50 nm. The direction of the high thermal conductivity are along the long axis as shown by the arrows of FIG. 5.

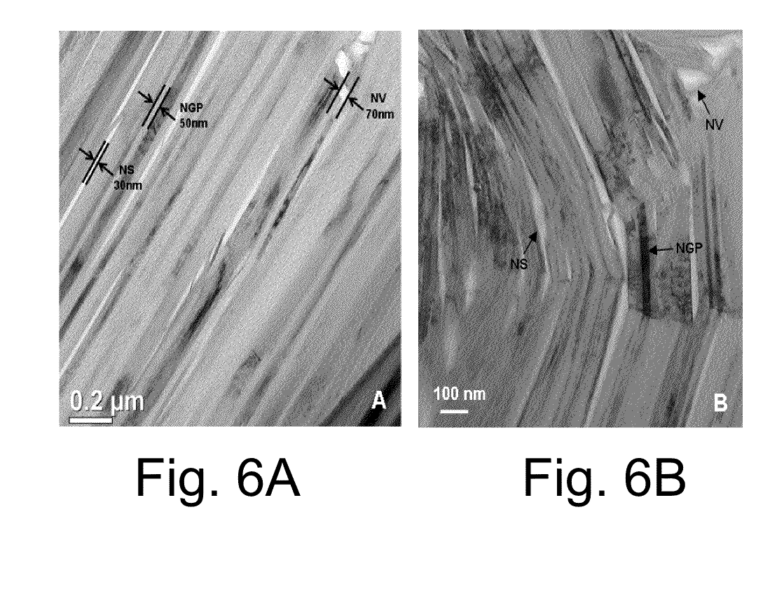

FIGS. 6A and 6B show additional TEM images of the nanographitic plates (labeled as “NGP”) of the carbonaceous matrix. The plates are oriented generally in the direction of the extrusion (FIG. 6A) and the direction of the press process (FIG. 6B). The ordered stacks of the nanographitic plates may promote efficient heat transfer in the direction of the long axis of the plates. FIGS. 6A and 6B also show nanovoids (labeled “NV”) and nanoslits (labeled “NS”), which are artifacts of the manufacturing process using carbon based particles. FIGS. 6A and 6B indicate nanovoids having a thickness of about 70 nm and nanoslits having a thickness of about 30 nm.

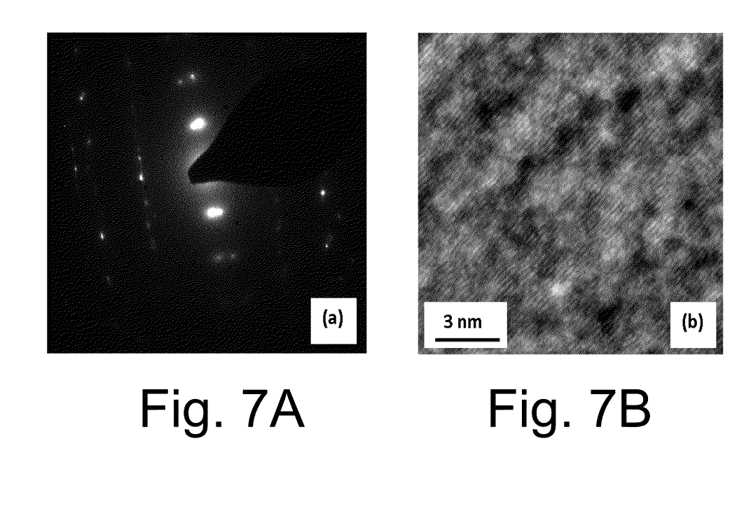

FIGS. 7A and 7B show TEM diffraction patterns and images of the carbonaceous matrix. The TEM diffraction pattern of FIG. 7A and the TEM image of FIG. 7B indicate the crystallinity and graphitic nature of the carbonaceous matrix formed during an extrusion process. In particular, FIG. 7A shows the diffraction pattern produced as the electrons interact with the crystalline lattice of the graphite material. Additionally, FIG. 7B, shows the lattice structure of the graphitic plates.

### Aluminum Impregnation Process

Although the thermal conductivity within the crystalline graphite of the carbonaceous matrix is high, pockets and pores (also referred to in this disclosure as “voids”) exist within the matrix. Phonons are transmitted readily through the graphite, but when it faces a void, the energy is reflected back and dissipated into the material. A mechanically strong and thermally conductive material may be injected into these pores, to promote more efficient heat transfer through the carbonaceous matrix while at the same time strengthening or altering the mechanical properties in a specified way. In addition, temperature and pressure of the process may be controlled to suppress formation of certain products, such as aluminum carbide, and also to insure maximum filling of voids in the carbonaceous matrix.

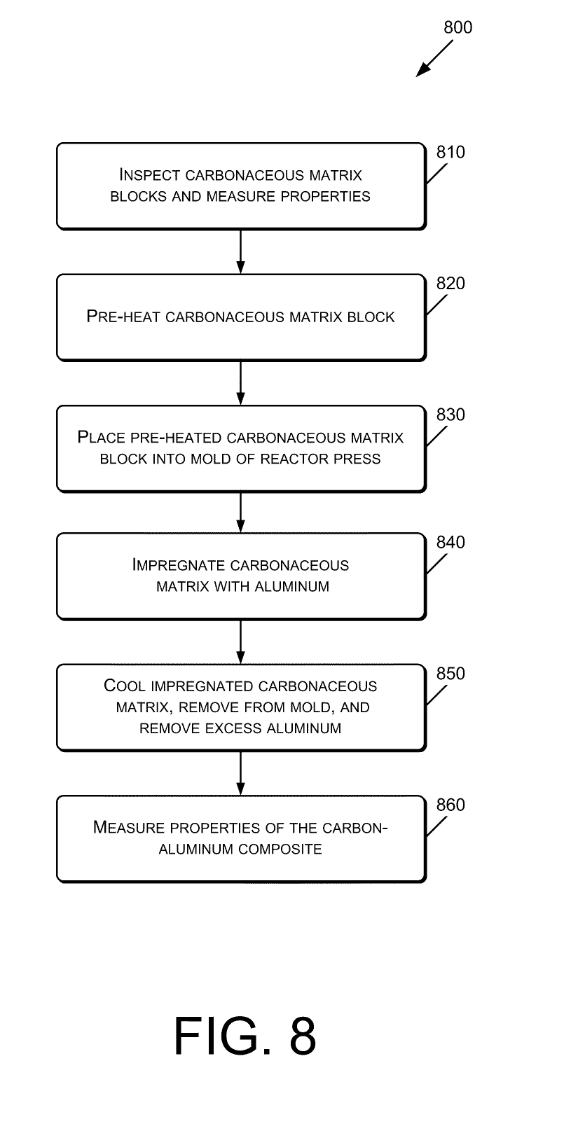

FIG. 8 shows a flow diagram of a method 800 of manufacturing a carbon-aluminum composite thermal management material. At 810, carbonaceous matrix blocks are inspected visually and properties of the blocks are measured. In an illustrative embodiment, the blocks are tested to determine whether the blocks have a density in a range of 1.6 g/cm³ to 1.9 g/cm³ and to determine whether the blocks have a resistivity in a range of 4 μΩ m-10 μΩ m.

At 820, the carbonaceous matrix is pre-heated to a temperature of about 700° C. and this temperature is sustained for a period of at least about 1 hour. While the carbonaceous matrix is being pre-heated, a die and a mold of a reactor press are heated to a temperature of about 250° C. When the mold and die and the carbonaceous matrix have been pre-heated, the carbonaceous matrix is transferred to the mold.

In addition, during the pre-heating of the die, aluminum and/or aluminum alloy is heated to a temperature in a range of 700° C. to 750° C., which is above the aluminum melting point of about 660° C. In some embodiments, dopants/additives are pre-incorporated into the aluminum prior to melting. In other embodiments, the dopants are added to the aluminum during the aluminum melting process.

At 830, the preheated carbonaceous matrix is placed into the mold of the reactor press. In some embodiments, the mold is a circular cylindrical shape with an inner diameter of about 350 cm and a depth of about 500 mm, while the carbonaceous matrix blocks are rectangular with dimensions of about 150 mm×about 200 mm×about 250 mm. In other embodiments, the mold is about 1 m in diameter and about 500 mm deep.

At 840, the impregnation process takes place. In particular, the molten aluminum is filled into the mold and a 1500 ton press is lowered. The aluminum initially fills the spaces in the mold which are not occupied by the carbonaceous matrix. In a particular embodiment, the pressure exerted onto the carbonaceous matrix during this step is up to about 100 MPa for a duration in the range of 10 minutes to 20 minutes at a temperature in a range of 700° C. to 800° C. In an illustrative embodiment, the pressure applied is about 100 MPa for about 10 minutes.

At 850, after the carbonaceous matrix has been impregnated with the molten aluminum, the carbon-aluminum composite is cooled and removed from the mold. In addition, any excess aluminum may be removed. The excess aluminum may be re-heated and used to impregnate subsequent carbonaceous matrixes. In some embodiments, the carbon-aluminum composite includes about 80% carbon and about 20% aluminum material. The aluminum material may comprise aluminum, any dopants that have been added to the aluminum, other reaction products, or a combination thereof. Further, in some embodiments, at least 90% by volume of the pores of the carbonaceous matrix are filled with the aluminum material. In addition, the method 800 may produce a uniform distribution of the aluminum material through the carbonaceous matrix up to about 600 mm from the center of the block to the surface.

At 860, properties of the carbon-aluminum composite are measured. In a particular embodiment, thermal properties of the carbon-aluminum composite may be tested using LFA 502 laser flash analysis equipment. In some embodiments, the testing system may be calibrated using a copper standard sample measurement, with the data deviation calculated to be smaller than 3%. For example, a KEM laser flash measurement system may measure the thermal diffusivity, thermal conductivity, and specific heat of the carbon-aluminum composite. The thermal conductivity of the carbon-aluminum composite may be in a range of 300 W/mK to 600 W/mK. Additionally, the thermal diffusivity of the carbon aluminum composite may be in a range of 0.8 cm²/s to 3.2 cm²/s. In a particular example, the thermal properties of a carbon-aluminum composite were measured using Laser Flash methodology according to ASTM E1461-92 indicating a thermal diffusivity of about 2.68 cm²/s and a thermal conductivity of about 463 W/mK.

Other properties of the carbon-aluminum composite may also be measured. For example, bend strength may be measured using a bend test system (AG-IS). In another example, the Young's modulus may be measured using a Young's modulus measurement instrument (YMC-2). In addition, a high throughput custom I-V measurement unit may measure electrical properties, such as resistance, conductance, etc. Further, precision scales and balances may measure mass and weight to give estimates of porosity before and after impregnation. A Raman analysis instrument may be utilized for analysis of crystalline structure of materials and a Coulter SA 3100 Surface Area and Pore Size Analyzer may monitor pore sizes and density of the carbonaceous matrix based on Bruner-Emmett-Teller (BET) analysis.

Additionally, the properties of the carbon-aluminum composite along a particular axis may depend on the process used to manufacture the carbonaceous matrix. For example, when the carbonaceous matrix is manufactured via an extruding process, heat may be dissipated faster in the Z-direction. In this example, a maximum thermal conductivity is parallel to the direction of extrusion during formation of the carbon-containing matrix. In another example, when the carbonaceous matrix is fabricated using a high pressure mold press, heat dissipation may be faster in the XY plane. In this example, a maximum thermal conductivity is perpendicular to a direction of pressure exerted by the high pressure mold press on the carbon-containing matrix during formation of the carbon-containing matrix. In addition, the properties of the carbon-aluminum composite may depend on the quality of the starting material (i.e. the properties of the carbonaceous matrix prior to the addition of Al) and process conditions, such as the temperature and pressure applied during the process of impregnating the carbonaceous matrix with Al, and the amount of time that the carbonaceous matrix, Al, and/or any additives are subjected to the process conditions.

Table 1 shows properties for samples of the carbon-aluminum composite made from a carbonaceous matrix manufactured using an extrusion process and Table 2 shows properties of samples of the carbon-aluminum composite made from a carbonaceous matrix manufactured using a high pressure mold press.

TABLE 1

| Plane | | X, Y | Z |
|---|---|---|---|
| Thermal Diffusivity | cm²/sec | 1.1-1.5 | 2.3-2.6 |
| Thermal | W/mK | 150-250 | 300-500 |
| Conductivity | | | |
| Coefficient of | 10⁻⁶/K | — | less than 8 |
| Thermal Expansion | | | |
| Electric Resistivity | μΩ m | 5 | 4 |
| Specific Heat | J/gK | 0.60-0.81 | 0.60-0.81 |
| Specific Gravity | g/cm³ | 2.0-2.5 | 2.0-2.5 |
| Bending Strength | MPa | 19-27 | 39-53 |
| Young's Modulus | GPa | 1.5-2.2 | 3.7-4.9 |

TABLE 2

| Plane | | X, Y | Z |
|---|---|---|---|
| Thermal Diffusivity | cm²/sec | 2.0-2.5 | 0.8-1.3 |
| Thermal | W/mK | 400-500 | 175-225 |
| Conductivity | | | |
| Coefficient of | 10⁻⁶/K | — | less than 8 |
| Thermal Expansion | | | |
| Electric Resistivity | μΩ m | 4 | 5 |
| Specific Heat | J/gK | 0.60-0.81 | 0.60-0.81 |
| Specific Gravity | g/cm³ | 2.0-2.5 | 2.0-2.5 |
| Bending Strength | MPa | — | — |
| Young's Modulus | GPa | — | — |

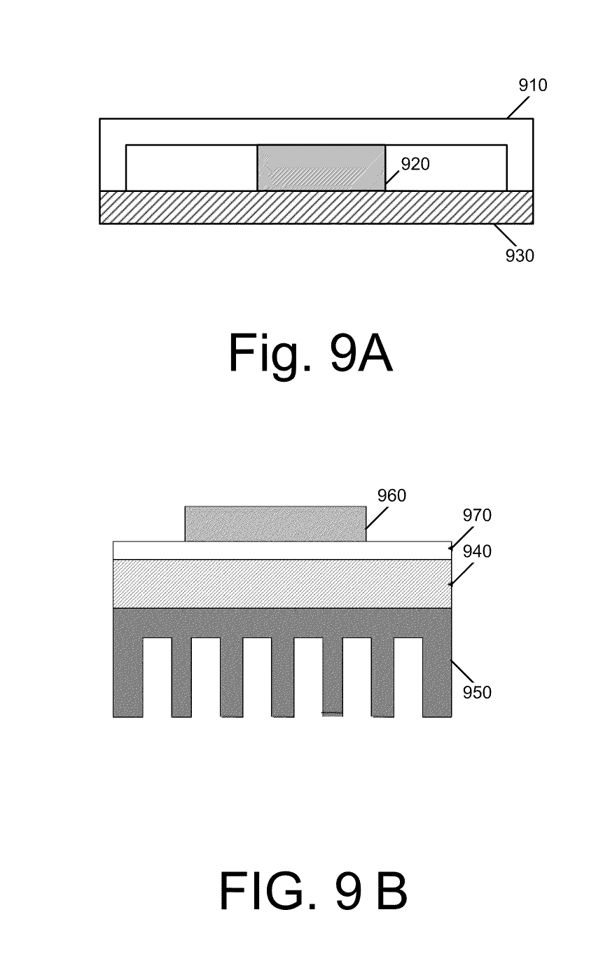

At 870, the carbon-aluminum composite may be machined according to specifications based on the end-product that will incorporate the carbon-aluminum composite. In some embodiments, the carbon-aluminum composite may be machined into a heat transfer device. In one example, the carbon-aluminum composite may be utilized as a heat spreader, such as the heat spreader 910 shown in FIG. 9A. In particular, the carbon-aluminum composite may be machined into the heat spreader 910 that dissipates heat from a computer chip 920 coupled to a substrate 930. Additionally, the carbon-aluminum composite may be used as a heat spreader coupled to a light emitting diode (LED). In another example shown in FIG. 9B, the carbon-aluminum composite 940 may be coupled a heat sink 950 that is coupled to a computer chip 960, such as an insulated-gate bipolar transistor (IGBT), via an insulating layer 970.

### Engineering of Interfacial Layer

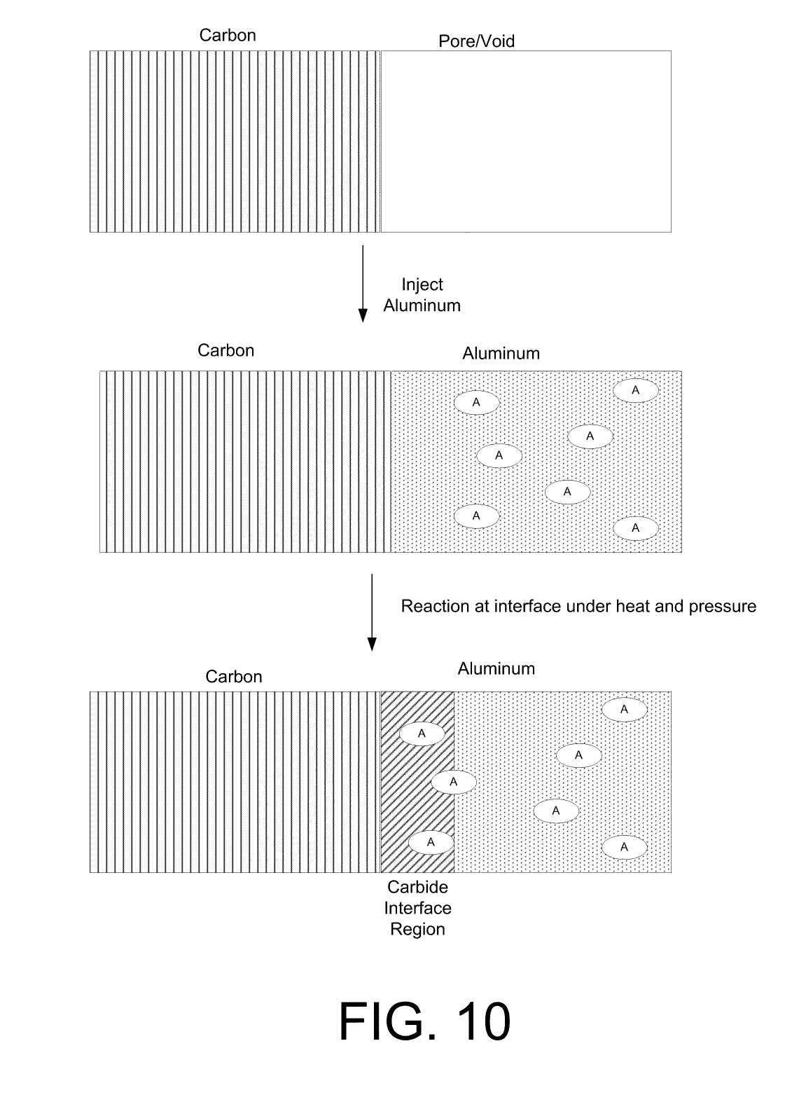

The process parameters have been optimized for the impregnation process of the carbonaceous matrix with a specially doped molten aluminum alloy. Through the control of these process parameters a nanometric interface between the aluminum and the carbonaceous matrix is created. FIG. 10 depicts the process of impregnation and creation of the interface between the carbonaceous matrix and the metal. As shown in FIG. 10, the carbonaceous matrix has pores and voids. Molten metal, in this example aluminum, is injected into the carbonaceous matrix at specified temperatures and pressures for a particular amount of time, such that the molten metal fills at least a portion of the pores of the carbonaceous matrix. The molten metal may contain chemical additives (labeled as “A” in FIG. 10), such as Si. Initially the metal first contacts the carbon to create an interface. The temperature and pressure of the process cause at least a portion of the additive to diffuse to the carbon/metal interface. A reaction occurs under the process conditions to generate a carbide material at the interface. Through the control of the process parameters, that is the temperature and pressure, an interface between the aluminum and carbonaceous matrix is created. Further, the thickness and composition of the interface may depend on an amount of time that the process conditions are applied. The interface has a thickness that is on the order of nanometers. Excess additive that does not contribute to the reaction remains in the aluminum.

### Energy Transfer Through the Interface

Transfer of thermal energy (heat) can be accomplished by phonons. Phonons are lattice vibrations within a material. A phonon will travel through a material until it reaches a scattering point (material defect) or the edge (interface) of the material. Therefore the phonon will continue until it hits a defect site and is absorbed by the material or hits an outside edge. At an edge interface the phonon can continue on at a greatly reduced energy (radiation or coupling) or be reflected back into the material, which results in poor phonon propagation and low thermal transfer. The carbon-aluminum composite produced via the method described with respect to FIG. 8 may include a carbon/aluminum interface at the edge of graphitic sheets of the composite, as shown in FIG. 10. Thus, an energy barrier may be setup as a boundary between carbon and aluminum of the composite. In addition, given the reflectivity of the aluminum, phonons may be redirected back into the carbonaceous matrix where the phonons would eventually be absorbed as heat. However, the creation of a smoother interfacial layer between the carbon and aluminum of the composite may allow phonons to more efficiently continue traveling across the carbon/aluminum interface.

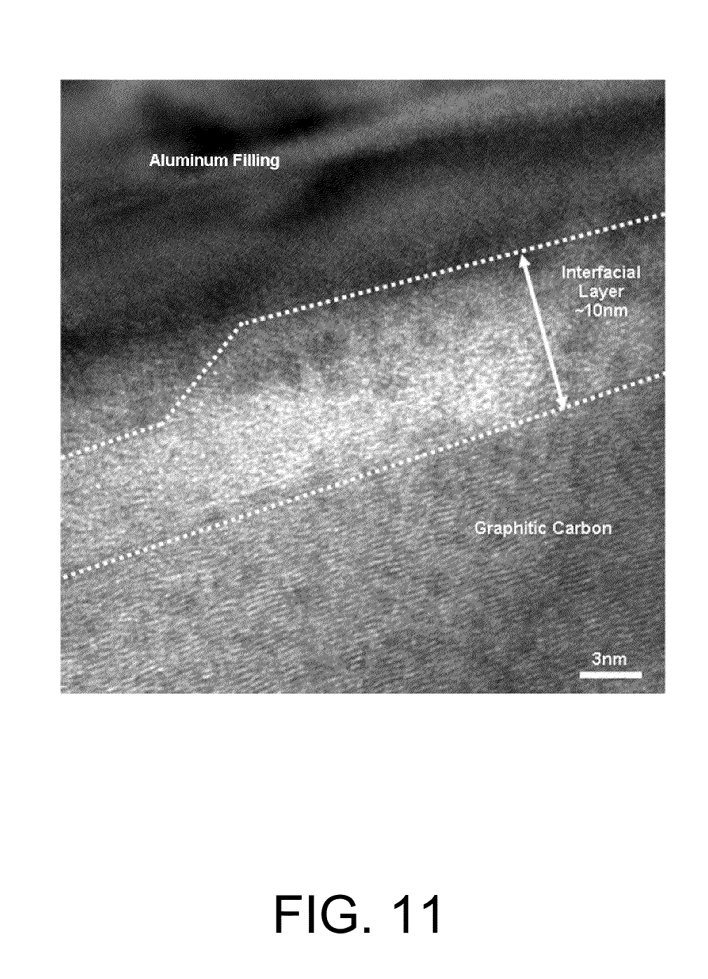

In some embodiments, a thickness of the interface between carbon and aluminum in the composite is less than about 100 nm to allow efficient phonon transfer across the interface between carbon and aluminum. The thickness of the carbon-aluminum interface, as well as any voids or defects of the interface may affect the phonon transfer across the interface. In addition, the thickness of the interface may be engineered based on the phonon wavelength in graphite, which is on the order of nanometers. The thickness of the carbon and aluminum interface may also be affected by the percentage of a particular dopant in the aluminum material. In a particular embodiment, a lower concentration of the dopant may control the thickness of the interface between the aluminum and carbonaceous matrix, such that the thickness is less than about 100 nm. FIG. 11 shows a very high magnification TEM image of the interfacial layer showing about a 10 nm interface between the graphitic carbon and the aluminum filling material.

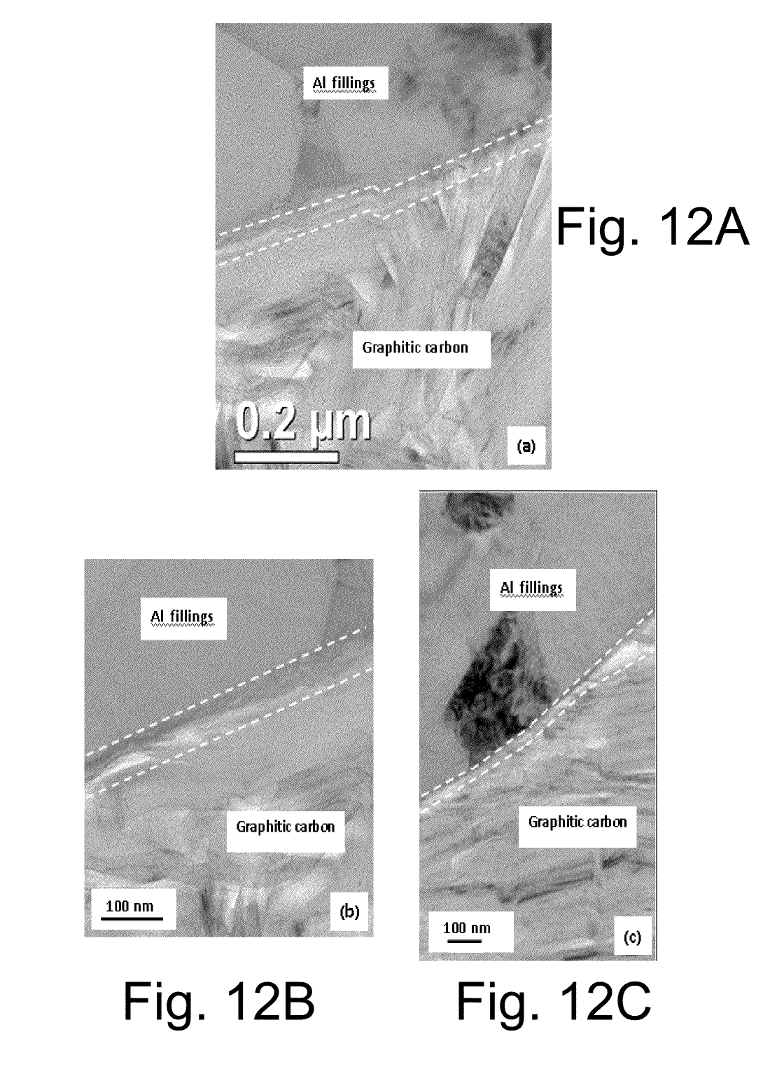

FIGS. 12A, 12B, and 12C show TEM images, taken at various locations in the carbon-aluminum material. The dashed white designation lines are placed to approximate the transition from the ordered graphitic plates to the more amorphous interface layer, and finally to the bulk aluminum filling. As shown in FIGS. 12A, 12B, and 12C, the thickness of the interface layer ranges between about 10 nm and about 40 nm.

For the carbon-aluminum composite material, due to the surface area of the carbon-aluminum interface, the contribution from the thermal conductivity at the interface may be significant. Therefore, the nature of the carbon-aluminum interface may be important to the thermal properties of the carbon-aluminum interface. One factor that may influence the thermal behavior of the composite at the carbon-aluminum interface relate to material “wetting”, that is, graphite has a poor affinity to aluminum due to a difference in surface tension. Therefore, it is necessary to improve the contact between the carbon and aluminum and reduce any interfacial voids that may form during the molten aluminum liquid cooling process.

Another factor that may influence the thermal behavior of the composite at the carbon-aluminum interface relates to carbide formation. In particular, since aluminum is filled into the carbonaceous backbone at high temperature and high pressure conditions, an aluminum carbide, Al₄C₃, could locally form at the interfacial regions. The Al₄C₃ has poor thermal conductivity and furthermore it is easily hydroscopic, magnifying the surface tension issues of the graphite-aluminum interface.

The addition of suitable additives including, but not limited to trace elements or compounds, such as silicon, into the aluminum may affect the thermal properties of the carbon-aluminum composite. Examples of the effect of silicon on the thermal properties of the carbon-aluminum composite may include:
(i) The addition of silicon may decrease the melting point of aluminum, leading to less power consumption during the process of metal impregnation into the carbonaceous backbone.
(ii) The addition of silicon may reduce the viscosity of molten aluminum liquid, making it easier to fill any voids of the porous carbonaceous backbone. Sufficient void filling may improve the thermal management behavior of the composite and also enhance the material strength and robustness of the carbon-aluminum composite.
(iii) The silicon additive may effectively suppress Al₄C₃ through formation of interfacial silicon crystals and silicon based carbides. The Al₄C₃ is brittle, hydroscopic, and has a low thermal conductivity. Therefore, suppression of Al₄C₃ may improve the thermal conduction, mechanical properties, chemical stability and erosion-resistance of the carbon-aluminum composite.

### Wettability

Carbon materials and molten metals may have poor wettability due to a poor affinity between the materials. Accordingly, molten aluminum applied to the carbonaceous matrix may not wet the surface of the carbonaceous matrix, which may result in a high contact angle causing the molten aluminum to bead together. Thus, the loss of contact between the aluminum and carbonaceous matrix may create voids in the interface between the aluminum and carbonaceous matrix.

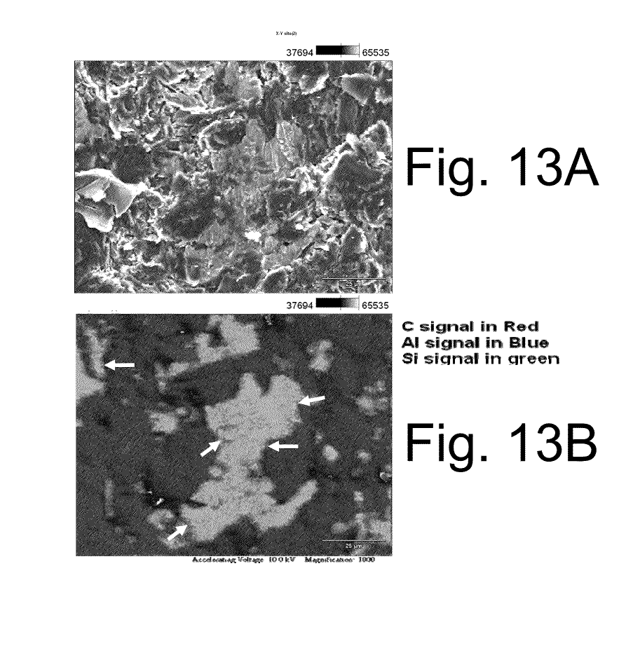

A silicon dopant may change the surface energy of the aluminum, so that the aluminum may wet the surfaces of the carbonaceous matrix instead of beading up at a high contact angle. In this way, the aluminum may be able to fill voids of the carbonaceous matrix. FIG. 13A shows a Scanning Electron Microscope (SEM) image for the carbon-aluminum composite and FIG. 13B shows a corresponding Energy Dispersive X-ray (EDX) analysis for the carbon-aluminum composite. The EDX image of FIG. 13B demonstrates the filling of the aluminum into the carbonaceous matrix from a macro level view at the micron length scale. FIG. 13B indicates that the aluminum efficiently fill the voids in the carbonaceous matrix. In addition, a small amount of silicon, such as between about 0% and less than 11%, has been incorporated into the aluminum starting material and the image of FIG. 13B appears to indicate that the silicon content localizes at the interface between the carbon and aluminum as indicated by the arrows, suggesting that trace amounts of silicon precipitate near the carbon and aluminum interface.

### Suppression of Aluminum Carbide

The formation of Al₄C₃ may lower the phonon coupling and propagation between the aluminum and carbonaceous matrix, thus lowering the thermal conductivity as well as the mechanical strength of the composite. A silicon dopant may be added during the impregnation process and migrate to the interface between the aluminum and carbonaceous matrix to suppress formation of aluminum carbide. The relationship between the silicon dopant and the formation of aluminum carbide may be described by the following reaction:

4Al+3SiC<=>Al₄C₃+3Si Reaction 1

Following Le Chatelier's principle, the equilibrium can be shifted depending on the concentration of the reactants or the products. For example in Reaction 1, if there is excess of SiC, more aluminum carbide will be formed as the reaction is shifted to the right. By contrast if there is excess silicon present, the reaction will shift to the left leaving SiC and, depending on reaction conditions, AlₐSi_{b}C_{c} as products. Thus, by manipulating the silicon content of the carbon-aluminum composite, it may be possible to suppress Al₄C₃ formation. In particular, the silicon additive may effectively suppress the Al₄C₃ phase through formation of interfacial silicon crystals and silicon based carbides.

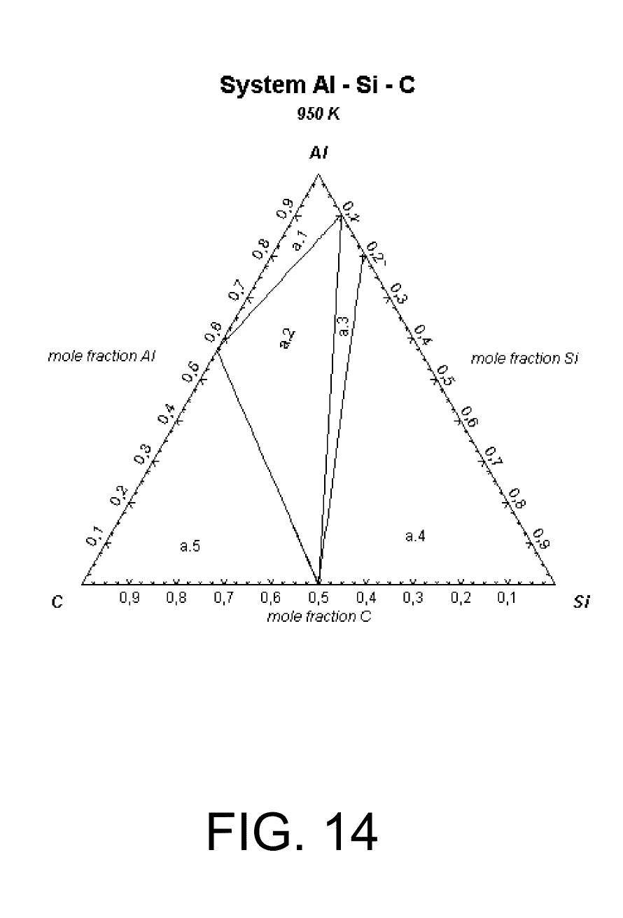

A tertiary phase diagram for Si, Al and C is shown in FIG. 14. The reaction between these three elements, silicon, aluminum, and carbon, can generate four possible combinations: aluminum silicide (AlₓSi_{y}), aluminum carbide (Al₄C₃), silicon carbide (SiC) and aluminum silicon carbide (AlₐSi_{b}C_{c}). The phase diagram of FIG. 14 indicates a region where the generation of SiC and AlₐSi_{b}C_{c} is formed. The phase diagram listed is for synthesis at ambient pressure. Similar phases can exist at high pressure although the concentrations and diagram lines may change positions. According to the phase diagram of FIG.14, as silicon content is increased, the phase shifts to suppress AlₐSi_{b}C_{c} formation. For example, for the phase diagram of FIG. 14, above a silicon mole fraction of about 0.07-0.08 the silicon carbide phase becomes thermodynamically stable and generation of interfacial aluminum carbide can be effectively suppressed. The phase diagram of FIG. 14 may be found in “On the Stability Range of SiC in Ternary Liquid Al—Si—Mg Alloy” by Yaghmaee, M. S., Kaptay, G., http://www.kfki.hu/˜anyag/tartalom/2001/jul/kaptay_yaghmaee.htm.

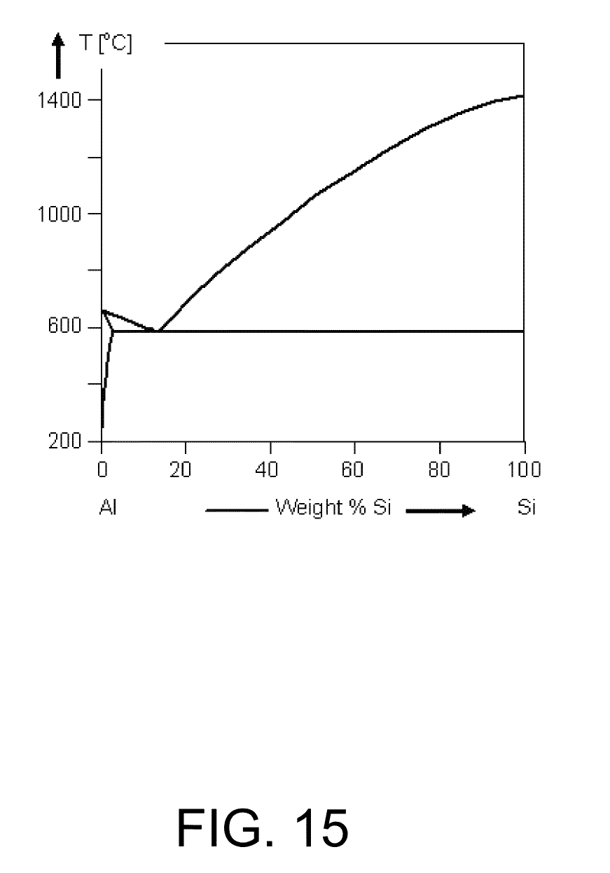

In order to avoid the formation of a primary silicon phase upon crystallization, the silicon content should be kept below the eutectic concentration. For example, according to the aluminum and silicon phase diagram of FIG. 15, the eutectic concentration for silicon is about 0.122. Accordingly, in some embodiments, the amount of silicon in the aluminum material used to impregnate the carbonaceous matrix may be between about 5% to less than 11% by mass. Therefore, by careful control of the silicon concentration in the molten aluminum, the formation of Al₄C₃ may be suppressed, but the amount of reactants available to form the interface layer may be controlled in order to limit the thickness of the interface.

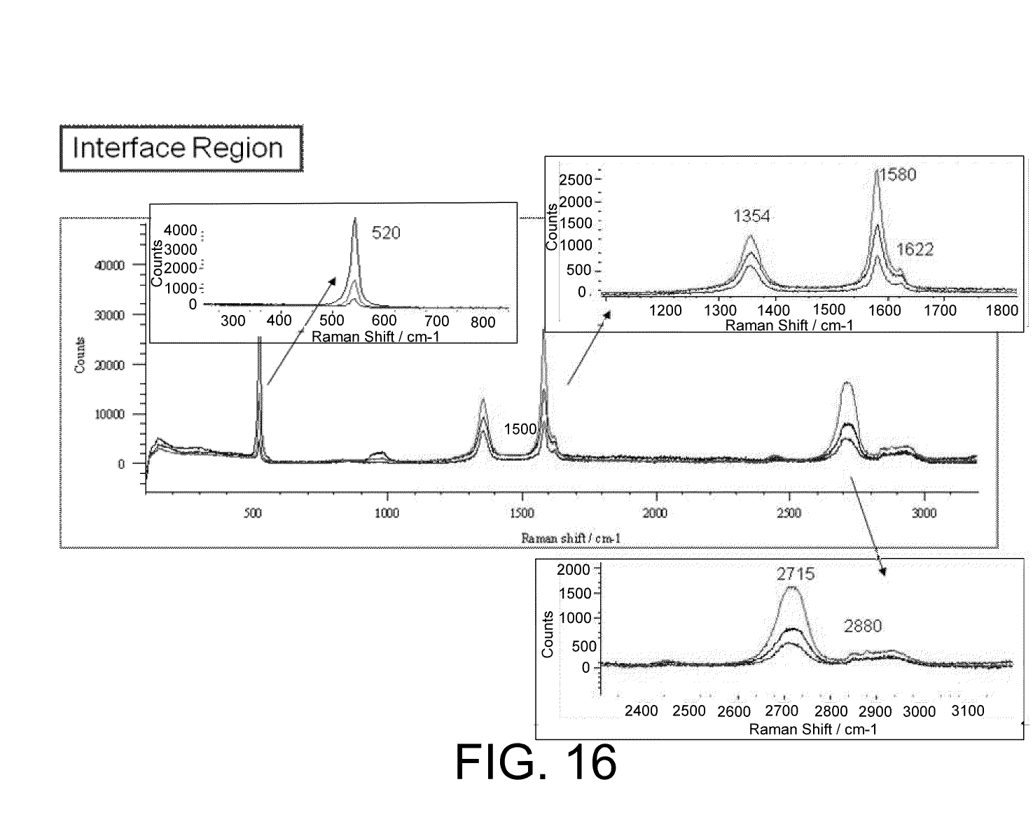

FIG. 16 shows a graph that illustrates a Raman spectra of a carbon-aluminum composite. The data may be collected near the interface of the carbon and aluminum in a composite. In this example, analysis of the combined carbon-aluminum composite includes seven peaks. In addition to the four major peaks from the graphitic backbone mentioned with respect to FIG. 4, there is a distinct sharp peak centered at about 520 cm⁻¹ and two minor peaks at about 980 cm⁻¹ and about 2880 cm⁻¹. The peak at about 520 cm⁻¹ is a crystalline silicon peak. The peak at about 980 cm⁻¹ is a second order crystalline silicon peak.

The Raman spectra of the carbonaceous backbone shown in FIG. 4 prior to the addition of aluminum may be compared with the Raman spectra of the carbon-aluminum composite of FIG. 16. In particular, the shoulder peak at about 1620 cm⁻¹ of FIG. 16 is more pronounced than the shoulder peak at about 1620 cm⁻¹ of FIG. 4 and the ratio of the D to G band (I_{d}/I_{g}) is reduced to approximately 0.5 in FIG. 16. These traits suggest that the carbon is more ordered after metal impregnation. The additional ordering of the carbon may be caused by the silicon aggregating in the aluminum-carbon interfacial region reacting with amorphous carbon rather than with crystalline graphite (i.e. ordered carbon).

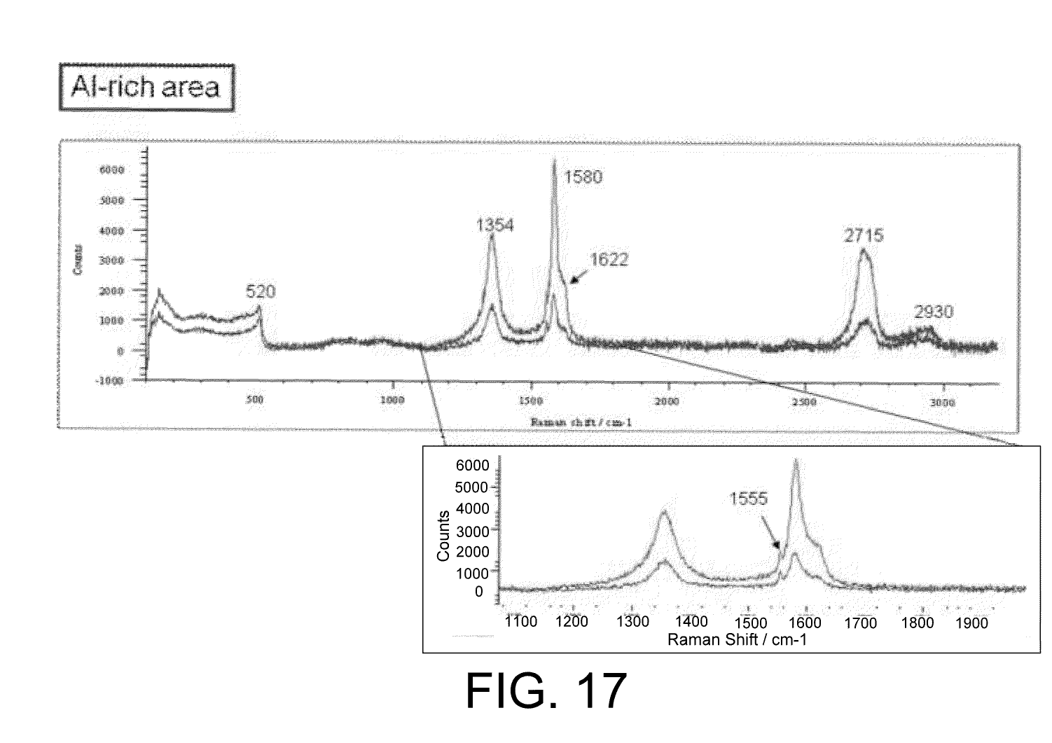

FIG. 17 shows a graph of a Raman spectra of the aluminum-rich area in the carbon-aluminum composite. The Raman spectra show nearly the same peaks as the Raman spectra of the interface region in FIG. 16. However, the intensity of the silicon peak is reduced, indicating that in carbon-aluminum composite material, most of the silicon content accumulates in the carbon-aluminum interface region rather than in the aluminum grain body.

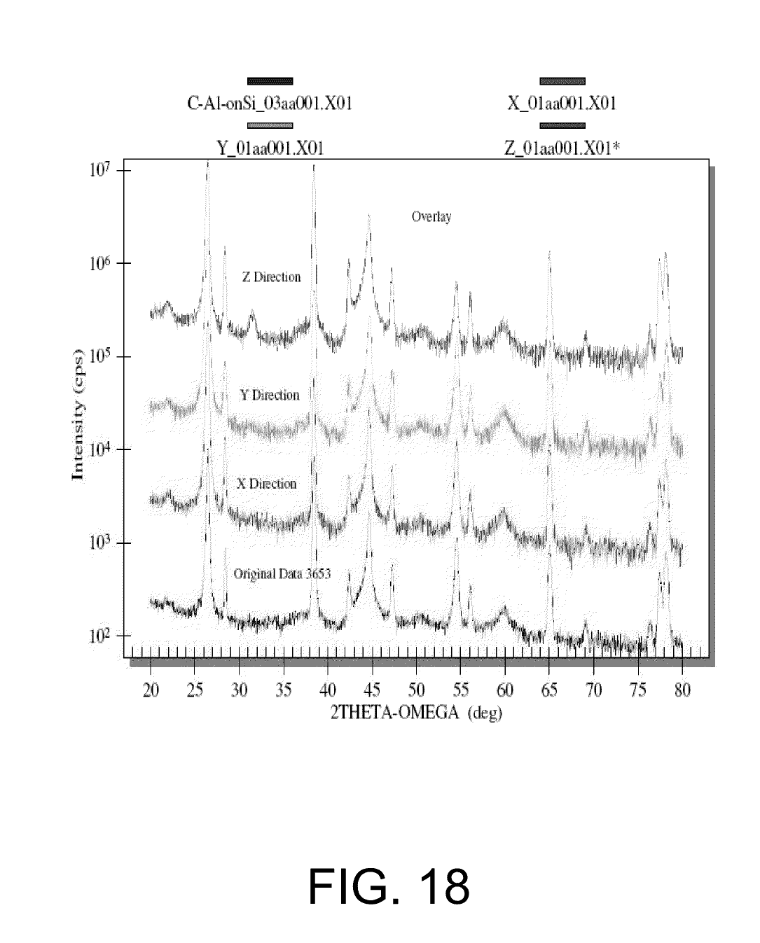

FIG. 18 shows a graph of an x-ray diffraction pattern (XRD) of the carbon-aluminum composite. In some instances, molten aluminum does not wet carbon spontaneously, due to the surface energy of carbon, while in other instances molten aluminum may eventually wet carbon at high temperatures under high pressure due to the formation of Al₄C₃ at the interface between the aluminum and the carbon. Thus, under high temperature and high pressure, interfaces between aluminum and carbon having thicknesses above 100 nm may be produced if aluminum carbide is formed at the interface due to high concentrations of aluminum and carbon at the interface. However, the XRD data of FIG. 18 shows that aluminum carbide is not detected in the carbon-aluminum composite using the XRD measurement equipment. The measurement equipment used is a Bede D-3 X-Ray Diffractometer. The experimental conditions were 40 keV; 200 mA; Front Slit 1 mm; Rear Slit 2 mm; Graphite Monochromator; 20-80 degrees; 0.02 deg steps; 0.5 second count time. The XRD data of the carbon-aluminum composite shown in FIG. 18 does show, however, that there are peaks associated with carbide formation within the carbon aluminum matrix associated with silicon carbide and aluminum silicon carbide. Accordingly, the addition of silicon may aid in suppressing the formation of aluminum carbide by altering the reaction chemistry at the interface.

A summary of the XRD peaks can be found in Table 3 below.

TABLE 3

XRD Peak Location (2θ-Ω)

| Peak Assignment | Measured Location | Reference Location |
|---|---|---|
| Carbon | 26.441 | 26 |
| Si | 28.38 | 28 |
| Al, SiC | 38.452 | 38.3 |
| SiC, Al₄SiC₄ | 42.38 | 42.5 |
| Al | 44.667 | 44 |
| Si | 47.248 | 47 |
| SiC | 54.450 | 54 |
| Si, Al₄SiC₄ | 56.037 | 56 |
| Al | 65.004 | 65.101 |
| Al | 77.38 | 78.23 |

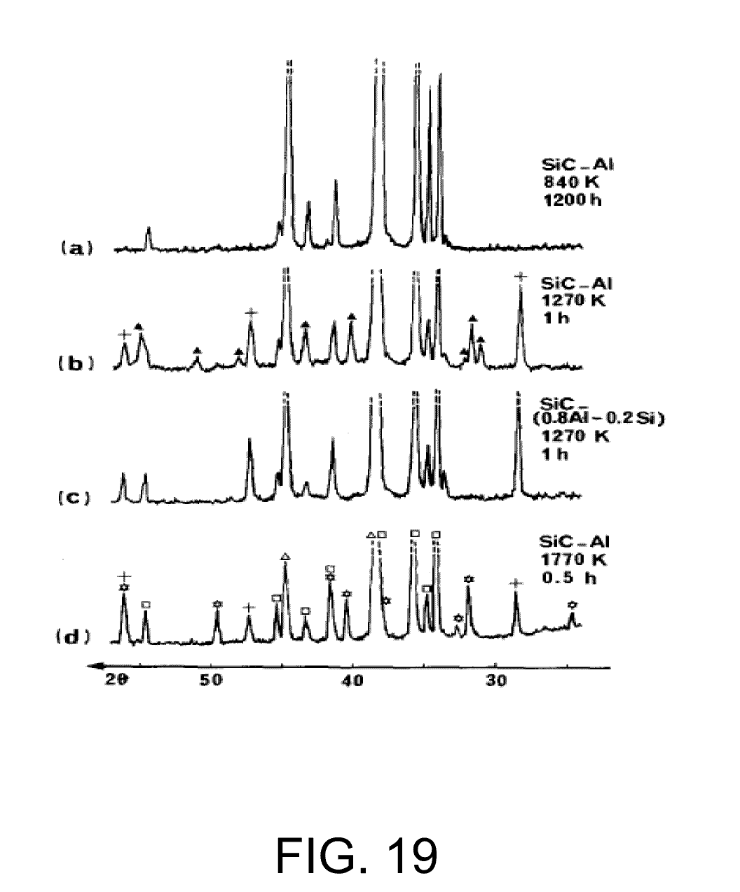

FIG. 19 shows a graph of reference peaks for XRD peak identification. There are several major peaks that may easily be identified. These are the carbon peak at about 26 and the aluminum peaks at about 38, about 65 and about 77. Several of the peaks identified correspond with either silicon carbide or aluminum silicon carbide. These peak assignments are summarized in Table 3 above. The reference peaks of FIG. 19 and Table 3 can be found in “Stable and metastable phase equilibria in the chemical interaction between aluminum and silicon carbide”, by Viala, J. C., Fortier, P., Bouix, J., J. Mat Sci 25 (1990) 1842-1850. There are no observable XRD peaks associated with aluminum carbide (Al₄C₃), suggesting that aluminum carbide formation has been successfully suppressed at the interface region. The silicon based carbide at the interface might increase the thermal conductivity of the carbon-aluminum composite.

As a result of the nature of the initial components, the nature of the additives and the conditions of the manufacturing process, properties of a carbon-metal composite may be controlled in order to produce a carbon-metal composite having enhanced thermal and physical properties that can be used in a variety of heat transfer applications.

1. An article of manufacture comprising:
a carbon-containing matrix comprising at least one type of carbon material selected from the group comprising graphite crystalline carbon materials, carbon powder, and artificial graphite powder, or combinations thereof, the carbon-containing matrix comprising a plurality of pores;
a metal component comprising Al, alloys of Al, or combinations thereof, the metal component disposed in at least a portion of the plurality of pores; and
an additive comprising at least Si, at least a portion of the additive disposed in an interface between the metal component within the pores and the carbon-containing matrix, the additive enhancing phonon coupling and propagation at the interface.

2. The article of manufacture of claim 1, wherein the metal component is disposed in at least 90% by volume of the plurality of pores.

3. The article of manufacture of claim 1, wherein the additive is disposed in the metal component and in the interface.

4. The article of manufacture of claim 3, wherein the additive comprises less than 11% by mass of the metal component.

5. The article of manufacture of claim 3, wherein the additive comprises more than 5% by mass of the metal component.

6. The article of manufacture of claim 1, wherein the additive comprises Si crystals.

7. The article of manufacture of claim 1, wherein the interface comprises Si crystals, SiC, AlₐSi_{b}C_{c}, or combinations thereof.

8. The article of manufacture of claim 1, further comprising not more than 1% of Al₄C₃.

9. The article of manufacture of claim 1, wherein a thickness of the interface is less than 100 nm.

10. The article of manufacture of claim 1 having a thermal conductivity in the range of 300 W/mK to 600 W/mK.

11. The article of manufacture of claim 1 having a thermal diffusivity in the range of 0.8 cm²/s to 3.2 cm²/s.

12. A method of making the article of manufacture of claim 1 comprising:
providing the carbon-containing matrix, the metal component, and the additive to a mold;
pressurizing the mold to a pressure within the range of 80 MPa to 100 MPa, to a temperature in the range of 700° C. to 800° C. for a duration in the range of 10 minutes to 20 minutes.

13. The method of claim 12, further comprising pre-heating the carbon-containing matrix to a temperature in the range of 700° C. to 750° C. and pre-heating the mold and a die to a temperature of about 250° C. before pressurizing the mold.

14. The method of claim 12, further comprising melting the metal component at a temperature in the range of 700° C. to 750° C. before pressurizing the mold.

15. The method of claim 14, further comprising pre-mixing the additive with the metal component before melting the metal component.

16. The method of claim 14, further comprising adding the additive to the metal component after melting the metal component.

17. The method of claim 12, further comprising heating a carbon block to a temperature in the range 3200° C. to 3600° C. for a duration in the range of 2 days to 3 days to form the carbon-containing matrix.

18. The method of claim 17, further comprising extruding petroleum cork, needle cork, tar, or mixtures thereof, at a temperature in the range of 500° C. to 800° C. to form the carbon block.

19. The method of claim 12, further comprising machining the article of manufacture of claim 1 into a heat transfer device.

20. An article of manufacture made by a method comprising:
providing a carbon-containing matrix, an amount of Si, and solid or molten Al or alloy of Al to a mold, the carbon-containing matrix comprising at least one type of carbon material selected from the group comprising graphite crystalline carbon materials, carbon powder, artificial graphite powder, or combinations thereof; and
pressurizing the mold to a pressure within the range of 80 MPa to 100 MPa, to a temperature in the range of 700° C. to 800° C. for a duration in the range of 10 minutes to 20 minutes.

21. An article of manufacture comprising:
a carbon-containing matrix comprising at least one type of carbon material selected from the group comprising graphite crystalline carbon materials, carbon powder, and artificial graphite powder, or combinations thereof, the carbon-containing matrix comprising a plurality of pores; wherein the carbon-containing matrix is made by a high pressure mold press;
a metal component comprising Al, alloys of Al, or combinations thereof, the metal component disposed in at least a portion of the plurality of pores; and
an additive comprising at least Si, at least a portion of the additive disposed in an interface between the metal component within the pores and the carbon-containing matrix, the additive enhancing phonon coupling and propagation at the interface.

22. The article of manufacture of claim 21, wherein a maximum thermal conductivity is perpendicular to a direction of pressure exerted by the high pressure mold press on the carbon-containing matrix during formation of the carbon-containing matrix.

23. An article of manufacture comprising:
a carbon-containing matrix comprising at least one type of carbon material selected from the group comprising graphite crystalline carbon materials, carbon powder, and artificial graphite powder, or combinations thereof, the carbon-containing matrix comprising a plurality of pores; wherein the carbon-containing matrix is made by extrusion;
a metal component comprising Al, alloys of Al, or combinations thereof, the metal component disposed in at least a portion of the plurality of pores; and
an additive comprising at least Si, at least a portion of the additive disposed in an interface between the metal component within the pores and the carbon-containing matrix, the additive enhancing phonon coupling and propagation at the interface.

24. The article of manufacture of claim 23, wherein a maximum thermal conductivity is parallel to a direction of extrusion during formation of the carbon-containing matrix.
